(19) United States
(12) Patent Application Publication
(10) Pub. No.: US 2002/0157003 A1
(43) Pub. Date: Oct. 24, 2002

(54) Apparatus for secure digital signing of documents

(76) Inventor: Rouslan Beletski, Manotick (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 09/836,463

(22) Filed: Apr. 18, 2001

(51) Int. Cl. H04L 9/00

(52) U.S. Cl. 713/170; 713/186

(57) ABSTRACT

A data processor is disclosed for digitally signing electronic documents. The data processor is disposed within a secure housing. The data processor also has a display. Data to be digitally signed is displayed on the display in a secure fashion to ensure that what is displayed, once authenticated, is what is digitally signed. In order to authenticate the document, the data processor includes a transducer such as a fingerprint sensor.

### FIELD OF THE INVENTION

The invention relates generally to encryption and computer security and more particularly to a device for secure digital signing of electronic documents.

### BACKGROUND OF THE INVENTION

Historically, documents were authenticated based on seals. A ruler or a judge would have a signet ring and would imprint, therewith, a seal on a document to bear their official stamp. With the need for more common authentication, signatures were generally provided through the placement of a unique, hand-written name on a document. Though many instances of fraud based on forgery of signatures have been recorded, the signature is still generally considered to be a secure indication of an individual having originated a document or accepted a provision.

A significant advantage of signatures is that the authenticity of the ink and, therefore, of the originality can be ascertained. Often, only an original signed document is acceptable as evidence. This assures that the document that is seen as signed is the document the individual had before them when they signed it.

Today, more and more enterprises are discovering the value of electronic data storage and electronic documents. The availability of the Internet to the end user makes it possible for individuals to easily access the corporate network from home, or other remote locations.

Electronic documents typically have time data associated therewith indicating a time a file was created, modified, and so forth. Unfortunately, it is very easy to fraudulently modify these times. As such, the times and other data associated with a file are not reliable.

In order to improve security of electronic documents, it is now commonplace for some digital documents to be signed. Signing involves cryptographically securing a document in a fashion that is determinative of the origin of the cryptographic key and that is verifiable. Typically, digital signatures rely on encryption using asymmetric encryption keys.

Unfortunately, a digital signature is applied to digital data in a process that occurs within a processor. Typically, a user determines that data is to be digitally signed and then, upon user approval the data is provided to a processor with the user identification where the data is digitally signed. Unfortunately, a man-in-the-middle application could modify the data prior to it being provided to the processor. In such a case, a signed document is not what is intended by the user. In conclusion, it is not known exactly what electronic data is being digitally signed.

### Types of Encryption Algorithms

Several standards exist today for privacy and strong authentication on the Internet through encryption/decryption. Typically, encryption/decryption is performed based on algorithms which are intended to allow data transfer over an open channel between parties while maintaining the privacy of the message contents. This is accomplished by encrypting the data using an encryption key by the sender and decrypting it using a decryption key by the receiver. In symmetric key cryptography, the encryption and decryption keys are the same.

Encryption algorithms are typically classified into public-key and secret key algorithms. In secret-key algorithms, keys are secret whereas in public-key algorithms, one of the keys is known to the general public. Block ciphers are representative of the secret-key cryptosystems in use today. Usually, for block ciphers, symmetric keys are used. A block cipher takes a block of data, typically 32-128 bits, as input data and produces the same number of bits as output data. The encryption and decryption operations are performed using the key, having a length typically in the range of 56-128 bits. The encryption algorithm is designed such that it is very difficult to decrypt a message without knowing the key.

In addition to block ciphers, Internet security protocols also rely on public-key based algorithms. A public key cryptosystem such as the Rivest, Shamir, Adelman (RSA) cryptosystem described in U.S. Pat. No. 5,144,667 issued to Pogue and Rivest uses two keys, one of which is secret—private—and the other of which is publicly available. Once someone publishes a public key, anyone may send that person a secret message encrypted using that public key; however, decryption of the message can only be accomplished by use of the private key. The advantage of such public-key encryption is private keys are not distributed to all parties of a conversation beforehand. In contrast, when symmetric encryption is used, multiple secret keys are generated, one for each party intended to receive a message, and each secret key is privately communicated. Attempting to distribute secret keys in a secure fashion results in a similar problem as that faced in sending the message using only secret-key encryption; this is typically referred to as the key distribution problem.

Key exchange is another application of public-key techniques. In a key exchange protocol, two parties can agree on a secret key even if their conversation is intercepted by a third party. The Diffie-Hellman exponential key exchange method, described in U.S. Pat. No. 4,200,770, is an example of such a protocol.

Most public-key algorithms, such as RSA and Diffie-Hellman key exchange, are based on modular exponentiation, which is the computation of α^{x} mod p. This expression means “multiply α by itself x times, divide the answer by p, and take the remainder.” This is very computationally expensive to perform, for the following reason. In order to perform this operation, many repeated multiplication operations and division operations are required. Techniques such as Montgomery's method, described in “Modular Multiplication Without Trial Division,” from Mathematics of Computation, Vol. 44, No. 170 of April 1985, can reduce the number of division operations required but do not overcome this overall computational expense. In addition, for present day encryption systems the numbers used are very large (typically 1024 bits or more), so the multiply and divide instructions found in common CPUs cannot be used directly. Instead, special algorithms that break down the large multiplication operations and division operations into operations small enough to be performed on a CPU are used. These algorithms usually have a run time proportional to the square of the number of machine words involved. These factors result in multiplication of large numbers being a very slow operation. For example, a Pentium® processor can perform a 32×32-bit multiply in 10 clock cycles. A 2048-bit number can be represented in 64 32-bit words. A 2048×2048-bit multiply requires 64×64 separate 32×32-bit multiplication operations, which takes 40960 clocks on the Pentium® processor. An exponentiation with a 2048-bit exponent requires up to 4096 multiplication operations if done in the straightforward fashion, which requires about 167 million clock cycles. If the Pentium processor is running at 166 MHZ, the entire operation requires roughly one second. Of course, the division operations add further time to the overall computation times. Clearly, a common CPU such as a Pentium cannot expect to do key generation and exchange at any great rate.

Because public-key algorithms are so computationally intensive, they are typically not used to encrypt entire messages. Instead, private-key cryptosystems are used for message transfer. The private key used to encrypt the message, called the session key, is chosen at random and encrypted using a public key. The encrypted session key and the encrypted message are then sent to the other party. The other party uses its private key to decrypt the session key, and then the message is decrypted using the session key. A different session key is used for each communication, so that if security of one session key is ever breached, only the one message encrypted therewith is accessible. This public-key/private-key method is also useful to protect continuous streams of data within communications, such as interactive terminal sessions that do not terminate in normal operation or that continue for extended periods of time. Preferably in this case, the session key is periodically changed by repeating key generation technique. Again, frequent changing of the session key limits the amount of data compromised when security of the session key is breached.

In order to digitally sign a document, a form of encryption is employed wherein a document is approved and then encrypted using a secret key. Using the public key corresponding to the secret key, the document can be decrypted to verify what was signed. A typical process works as follows: a document is reviewed for accuracy, once approved it is passed to an encryption module for digital signing thereof, the module signs the document and passes back a signed version of the document or of a portion of the document—typically a hash thereof. Of course, a man-in-the-middle can always intercept the approved document and replace it with a different document to be digitally signed. Since the hashing algorithms are known, there is no easy way to prevent such a man-in-the-middle attack presently available.

It would be advantageous to provide a more secure device for digital signatures.

### OBJECT OF THE INVENTION

In order to overcome these and other limitations of the prior art it is an object of the invention to provide a device more securely ensuring that data to be signed is actually the data reviewed by and accepted by an individual user of the device.

### SUMMARY OF THE INVENTION

In accordance with the invention there is provided a data processor for digitally signing electronic documents comprising:

a display for displaying data to be digitally signed;

a transducer for receiving the user authorization information and for providing user authorisation data based thereon; and,

a processor for providing data based on an electronic document for digitally being signed to the display in a secure fashion such that the displayed data is known to be based upon the electronic document, for receiving the user authorization data, for verifying the user authorization data against stored template data, and for digitally signing the electronic document upon determining that the user authorization data is provided from an authorised user,

wherein the processor provides the data based on the electronic document to the display for review prior to digitally signing the electronic document.

In accordance with another embodiment of the invention there is provided a data processor for digitally signing electronic documents comprising:

a processor for digitally signing electronic documents;

a transducer for receiving user authorization data; and,

a port electronically coupled to the processor for interfacing with a display to provide the processor with control over the display in order to display data for digital signature,

wherein the processor provides the data to the display for review prior to digitally signing the data.

In accordance with another aspect of the invention there is provided a method of digitally signing a document comprising the steps of:

providing the electronic document to a secure processor;

displaying data based on the electronic document, the data provided from the processor to a display along a secure communication path therebetween;

receiving authorization data; and

when the authorization data is indicative of an authorization to digitally sign the displayed data, digitally signing the electronic document to provide a signed document.

### BRIEF DESCRIPTION OF THE DRAWINGS

The invention will now be described with reference to the drawings in which like reference numerals refer to similar items and in which:

FIG. 1 is a reduced copy of a physical document with a handwritten signature thereon;

FIG. 2a is a simplified flow diagram of a prior art method of applying digital signatures using an encryption module;

FIG. 2b is a simplified data flow diagram illustrating a man in the middle attack on the prior art method of FIG. 2a;

FIG. 3 is a simplified diagram of a prior art digital signature module having a fingerprint scanner integrated therewith;

FIG. 4 is a simplified block diagram of an apparatus for secure digital signing of electronic documents according to the present invention;

FIG. 5 is a simplified flow diagram of a method of reviewing an electronic document and applying digital signatures thereto using an apparatus for secure digital signing according to the present invention;

FIG. 6 is a simplified block diagram of another embodiment of an apparatus for secure digital signing according to the present invention;

FIG. 7 is a simplified block diagram of still another embodiment of an apparatus for secure digital signing according to the present invention; and,

FIG. 8 is a simplified block diagram of an apparatus for secure digital signing that is embodied within in a personal digital assistant, according to yet another embodiment of the present invention.

### DETAILED DESCRIPTION OF THE INVENTION

In data processing it is common that data grouped together is referred to as a file. Of course, other data groupings may exist or more than a single grouping may be stored in a same physical file. That said, a single grouping is still often referred to as a file. Herein, the term digital document will be used to refer to electronic data forming a document or a grouping of data.

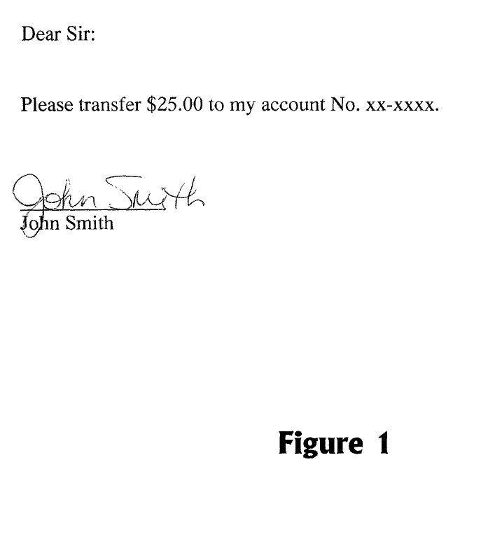

Referring to FIG. 1, a physical document is shown with a handwritten signature thereon. As is evident, in the process of signing the document, an individual can examine the document and ensure that their signature authenticates an accurate document.

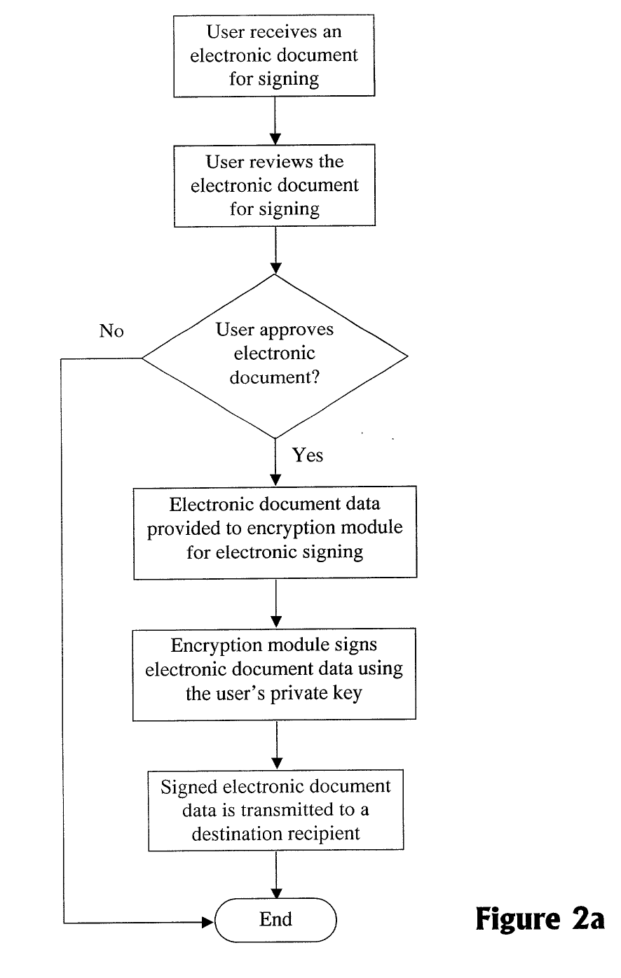

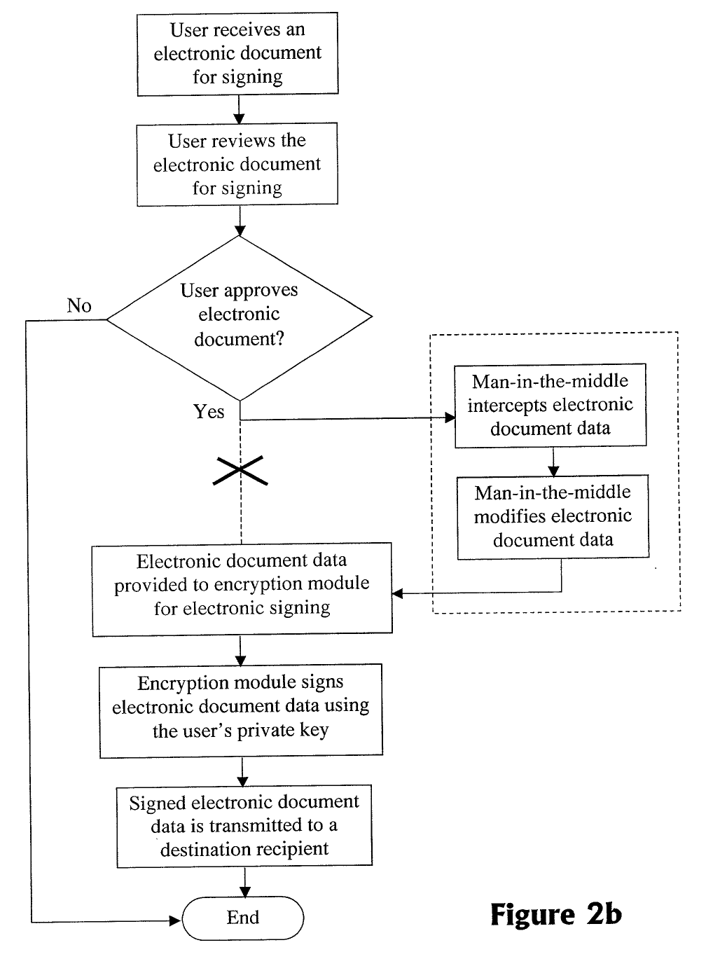

Referring to FIG. 2a, a simplified flow diagram of a prior art method of applying digital signatures using an encryption module is shown. A user reviews a document for signing. Upon approval of the document, the document data is provided to the module. The module then signs the document with the user's private key. As is evident from the flow diagram of FIG. 2b, a man-in-the-middle application can receive the data for signature and modify it before providing it to the module for signature. Also, a man-in-the-middle application can intercept user approval/disapproval. Then the man-in-the-middle application provides an approval to the module to initiate signature of a document other than the document for which the user has given approval for signing. Effectively, by showing the user an incorrect document, a veritable user approval code is used to authorise signature of an incorrect document.

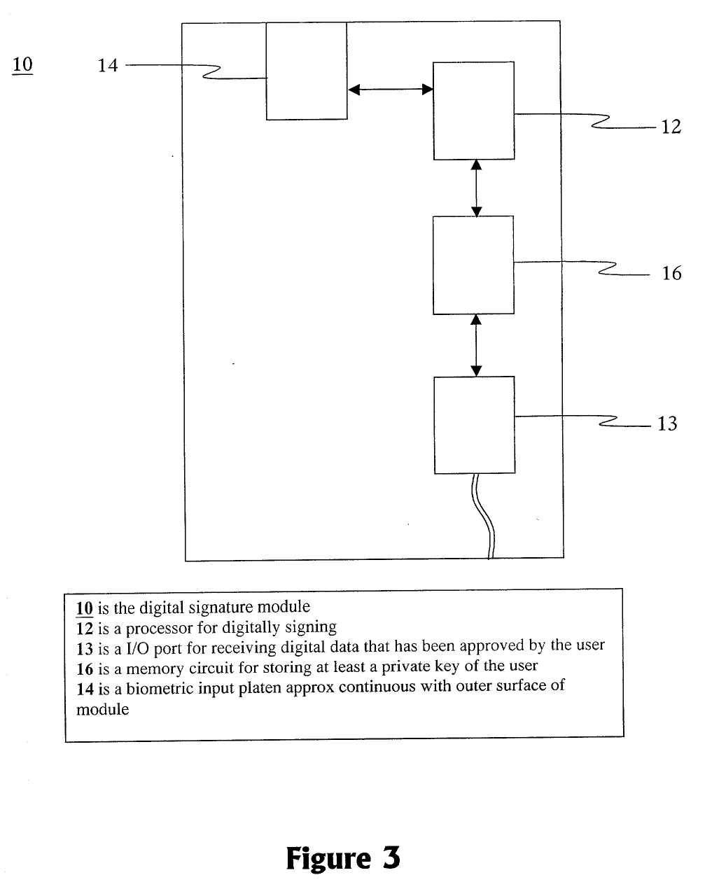

Referring to FIG. 3, a digital signature module as is known in the art and having a fingerprint scanner integrated thereon is shown. Here, an individual must authenticate themselves to the module in order to perform a signature function. Thus, one of the two man-in-the-middle attacks on signature security is obviated. A signature is known to have been authorised through presentation of biometric information from an authorised user—unless a false acceptance of biometric information has occurred. Unfortunately, the other man-in-the-middle attack—wherein the data displayed is not same data as that which is digitally signed—remains.

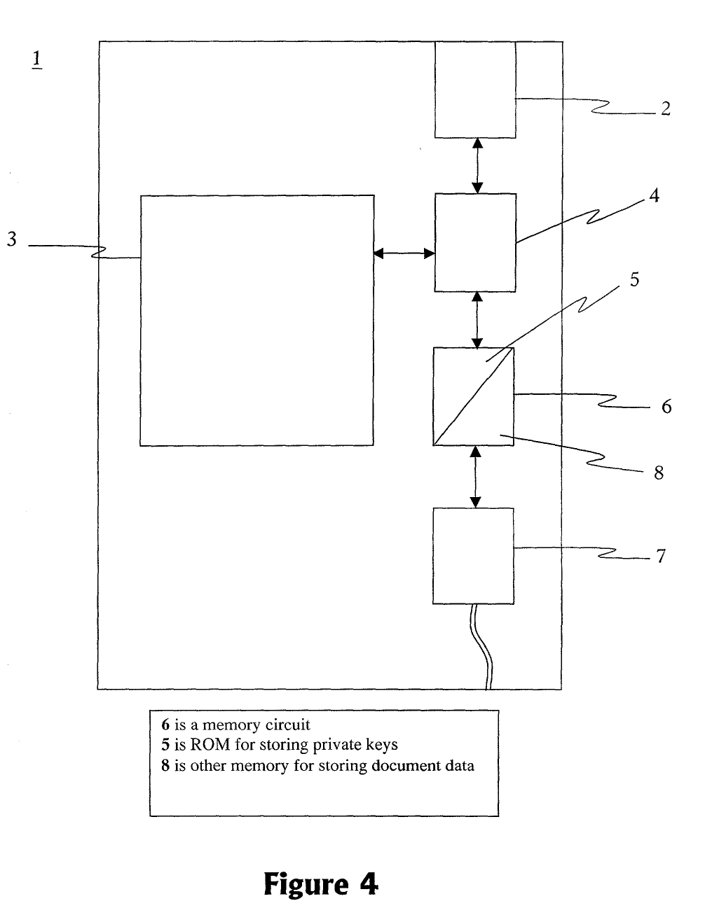

Referring to FIG. 4, a module 1 is shown having a transducer in the form of a biometric sensor 2, a display in the form of an LCD display 3, and a processor 4 for digitally signing an electronic document. The processor 4 is coupled to a read only memory (ROM) 5 for storing security data in the form of an encryption key for digitally signing data. Optionally, a clock (not shown) is included to provide timing data for use in timestamping. Within ROM is also stored executable instructions for execution by the processor 4 for operation of the module. A port 7 for receiving data to be digitally signed is provided in the form of a communication port. In use, an electronic document is received via the port 7. The electronic data is provided, for example, from a personal computer, an electronic transaction processing system, from a scanner, or from another electronic data source. Alternatively, the document is entered directly to the module via a transducer. The digital document is displayed in a human understandable format on the LCD display. The user is provided an opportunity to review the document on the LCD display. Known functions are typically supported such as scrolling through the document, enlargement of the document or portions thereof, and so forth. Once the user has reviewed the document and is satisfied with its contents, the user enters authorization data via the biometric sensor indicating an approval of the electronic document. Alternatively, the user enters an authorization code or another form of authorization data. The authorization data is then compared against stored template data to determine if it is authorization data acceptable for use in authorizing a digital signature. The electronic document is then digitally signed by the processor. Typically, the processor encrypts the document using a stored electronic key in accordance with standard digital signature methods. When the module supports several digital signatures, the authorization data is compared to several templates to determine a closest matching template. The digital signature key associated with the matching template data is then used in performing the digital signature.

Since the user reviews the electronic document and the electronic document is digitally signed with a same apparatus, the security of the digital signature is directly related to a security of the module. Also, since the digital signature is being performed on a module, it is possible to secure the electronic keys therein such that they are not accessible outside of the module. If the module is FIPS 140 level 2 or FIPS 140 level 3 compliant, the digital signature is secure in that the path from the processor to the display is known to be secure and therefore, what is presented to the user is known to accurately reflect that which is digitally signed. Even when the electronic document is provided from outside of the module, the received document is displayed and digitally signed within the module and therefore, a user, if they properly review the document before authorizing digital signing thereof is assured that what they reviewed is what was actually signed.

Of course, though the user authentication is illustrated as being biometric in nature, any form of user authorisation is possible including passwords, electronic keys, smart cards, and so forth.

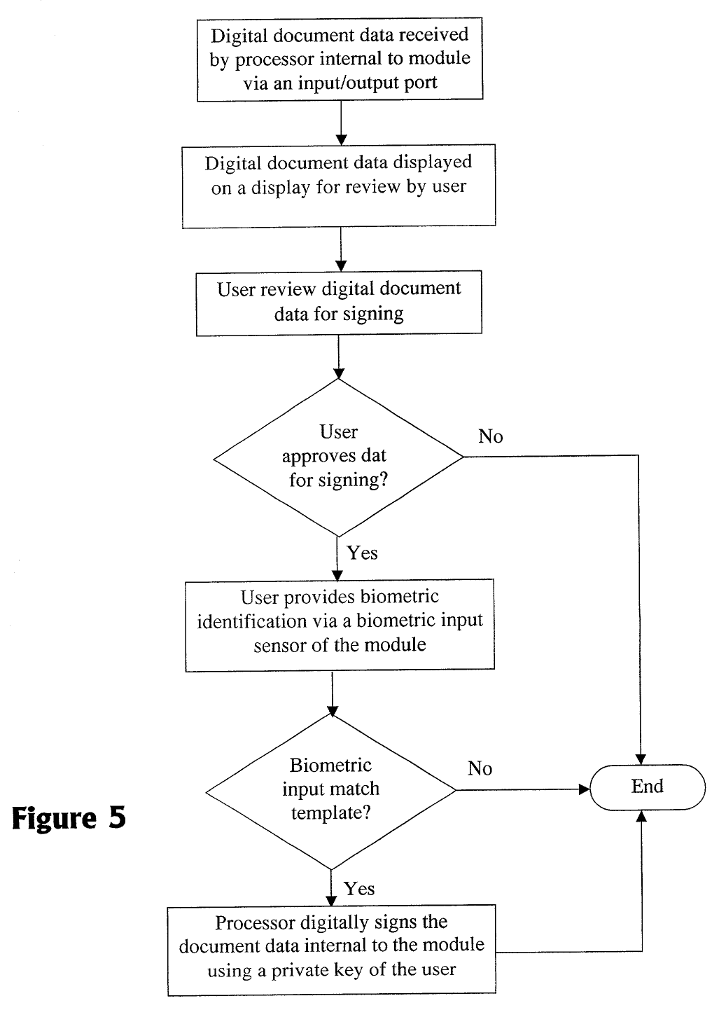

Referring to FIG. 5, a simplified flow diagram of a method according to the invention is shown. Here, a document is provided for review and signature. The document is provided to a module having a display wherein it is displayed and a processor for performing the digital signing operation. A user reviews the document on the display within the module and selects to sign the document or not. When the user selects to sign the document, a signal indicative of such is provided to the module. A processor within the module then cryptographically signs the document that is being displayed or was displayed to the user within the module.

The above method is immune to an effective man-in-the-middle attack. For example, a typical man-in-the-middle attack would require either that the document displayed is different from the document signed or that a digital signature is authorised without receiving proper authorization. Because the transducer is integral with the module as is the display, given a verified secure module, the document displayed on the display is the document that is digitally signed if proper user authorization data is provided.

For example, when a module is not being used to secure data but only to sign data, it is possible to provide the module with a wireless communication port because the data provided thereto is not secure data but merely data for being digitally signed. This provides convenience for users and flexibility allowing each of a plurality of users to have individual modules with their unique signature key stored therein in ROM. Upon engaging in a transaction, the transaction data is then communicated to the module for review and signature. Once reviewed, a user optionally accepts the transaction data and signs the transaction or rejects the transaction data. The signed transaction is communicated wirelessly to the vendor for storage and verification. Since the transaction itself is not confidential, the digitally signed data can be communicated in the clear to the vendor. Once verified, the transaction is complete. Optionally, the users module stores data relating to the transaction such that the user has a log of signed transactions.

According to the above example, credit cards are easily replaced with a small wireless module. In this manner, a user has the convenience of verifying their transactions and of storing each credit transaction or automated debit withdrawal—providing the convenience of chequing—while providing wireless transmission of credit card information, more secure signature methods, and so forth. For example, when the authorization data is user authentication data in the form of biometric data such as a fingerprint, it is known that a particular individual authorised digital signing of the transaction.

Since the security data in the form of an encryption key for use in performing the digital signature is unique to an individual, transactions, once signed, are known to originate from a particular module. Therefore, the digital signature method and apparatus provides a very secure credit system to replace credit cards. Here, a digitally signed transaction originates from an individual and is known to have been digitally signed by the module of that individual. As such, a private key replaces the credit card number and when using private-public key encryption for digital signing, the private key is secure and unknown. As such, credit transactions are implemented without possibility of stealing of credit card numbers or of most forms of credit card fraud.

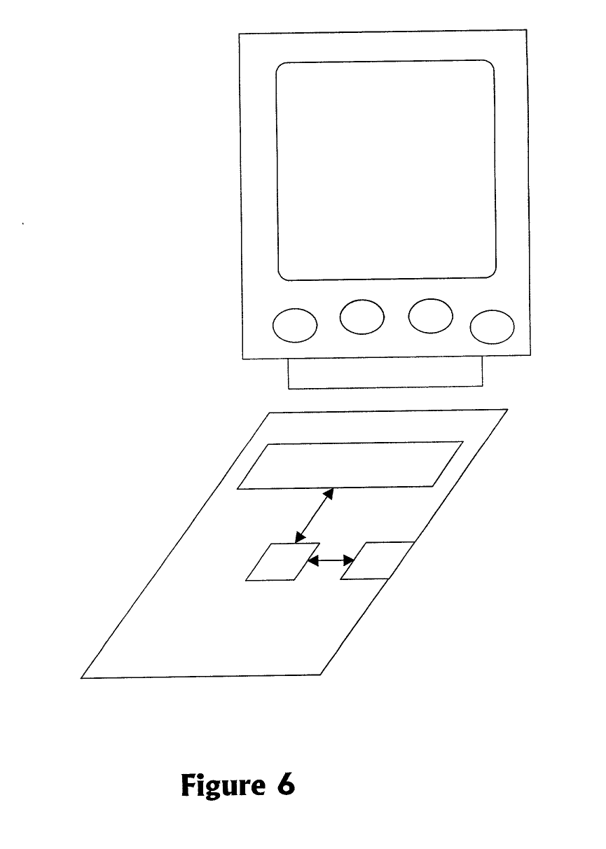

Referring to FIG. 6, another embodiment of the invention is shown wherein a personal digital assistant is provided with an interface slot. The interface slot is for interfacing with a module according to the invention. The module provides a processor for digitally signing electronic documents and a transducer for receiving user authorization data.

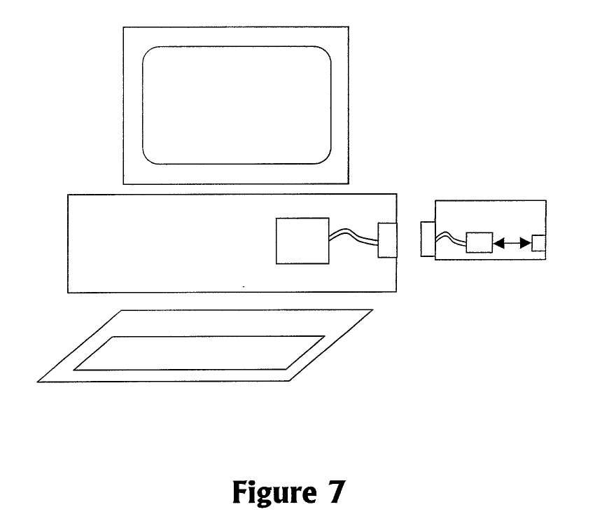

Referring to FIG. 7, another embodiment of the invention is shown wherein the module is inserted within a display device and provided with functionality to completely take over the display device or to interface directly with the display device. For example, a typical display such as those used for commonplace cash registers or personal computers is provided with an input port for interfacing with a module and for allowing a processor within the module to display data thereon. The module then acts to display the data on the display and sign the displayed data when authorization data is received via a transducer forming part of the module. In this way, the digital signature is an accurate signature on a properly reviewable document.

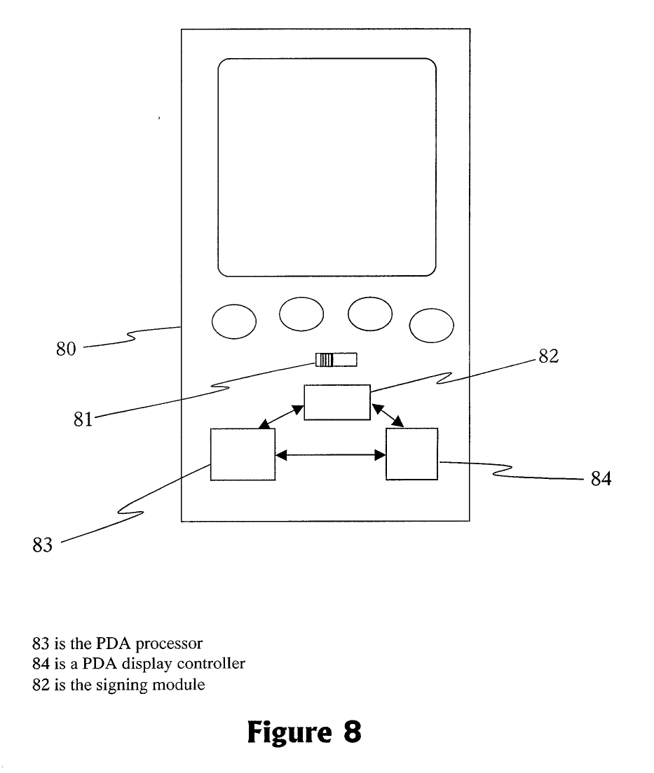

Referring to FIG. 8, a personal digital assistant is shown for use with the invention. Here the personal digital assistant 80 is shown having a switch 81 for switching the device from normal personal digital assistant functions to digital signing functions. In a first mode of operation the personal digital assistant performs date and time functions, address book functions and so forth. In the second mode of operation, a module within the personal digital assistant 80 provides for secure access from a processor therein to the display to display an electronic document for signing thereof. Thus, the personal digital assistant serves two functions rendering it far more cost effective.

Though many of the above embodiments are described with reference to biometric authentication for providing user authorisation for signing of electronic documents, other forms of authorising digital signatures such as codes, passwords, and so forth are also applicable to the present invention.

Numerous other embodiments may be envisaged without departing from the spirit or scope of the invention.

What is claimed is:

1. A data processor for digitally signing electronic documents comprising:
a display for displaying data to be digitally signed;
a transducer for receiving the user authorization information and for providing user authorisation data based thereon; and,
a processor for providing data based on an electronic document for digitally being signed to the display in a secure fashion such that the displayed data is known to be based upon the electronic document, for receiving the user authorization data, for verifying the user authorization data against stored template data, and for digitally signing the electronic document upon determining that the user authorization data is provided from an authorised user,
wherein the processor provides the data based on the electronic document to the display for review prior to digitally signing the electronic document.

2. A data processor for digitally signing electronic documents according to claim 1 wherein the display, the transducer, and the processor are disposed within a same secure housing.

3. A data processor for digitally signing electronic documents according to claim 2 wherein the secure housing forms part of a personal digital assistant housing.

4. A data processor for digitally signing electronic documents according to claim 1 wherein the processor and the display include a secure communication path therebetween.

5. A data processor for digitally signing electronic documents according to claim 4 wherein the secure communication path comprises a direct hardware coupling from the processor to the display.

6. A data processor for digitally signing electronic documents according to claim 5 comprising a second processor for performing general processing functions wherein the processor for digitally signing is a cryptographic processor for performing only security related processing.

7. A data processor for digitally signing electronic documents according to claim 5 comprising a read only memory circuit in electrical communication with the cryptographic processor, the read only memory circuit for storing at least a private key for digitally signing electronic documents.

8. A data processor for digitally signing electronic documents according to claim 1 comprising a second processor for performing general processing functions wherein the processor for digitally signing is a cryptographic processor for performing only security related processing.

9. A data processor for digitally signing electronic documents according to claim 8 comprising non-volatile storage including executable instructions stored therein for performing functions associated with a personal digital assistant.

10. A data processor for digitally signing electronic documents according to claim 9 comprising a second processor for executing the executable instructions.

11. A data processor for digitally signing electronic documents comprising:
a processor for digitally signing electronic documents;
a transducer for receiving user authorization data; and,
a port electronically coupled to the processor for interfacing with a display to provide the processor with control over the display in order to display data for digital signature,
wherein the processor provides the data to the display for review prior to digitally signing the data.

12. A data processor for digitally signing electronic documents according to claim 11 wherein the processor, the transducer, and the port are disposed within a same secure housing.

13. A data processor for digitally signing electronic documents according to claim 11 wherein the processor and the port include executable instructions and hardware for forming a secure communication connection between the processor and the display.

14. A data processor for digitally signing electronic documents according to claim 13 wherein the port is for coupling with a port of a personal digital assistant and wherein the port provides a direct coupling from the processor to the display of the personal digital assistant bypassing a processor of the personal digital assistant.

15. A data processor for digitally signing electronic documents according to claim 11 wherein the port is for coupling with a system having a second processor and wherein the port provides a direct coupling from the processor to the display bypassing the second processor.

16. A data processor for digitally signing electronic documents according to claim 11 wherein the port is for coupling with a secure system having a second processor and a display wherein the secure system is a trusted system.

17. A method of digitally signing a document comprising the steps of:
providing the electronic document to a secure processor;
displaying data based on the electronic document, the data provided from the processor to a display along a secure communication path therebetween;
receiving authorization data; and
when the authorization data is indicative of an authorization to digitally sign the displayed data, digitally signing the electronic document to provide a signed document.

18. A method according to claim 17 wherein the processor and the display are within a same secure tamper proof housing.

19. A method according to claim 18 wherein the secure processor is a cryptographic processor for performing only security related processing, and wherein a second processor is provided outside of the secure communication path for performing general processing functions relating other than to security.

20. A method according to claim 19 wherein the secure communication path between the processor and the display is an electronic coupling bypassing the second processor.

21. A method according to claim 18 wherein any instructions in execution on the processor is secure software that is verified by a secure entity.
